(19) United States
(12) Patent Application Publication
(10) Pub. No.: US 2010/0325545 A1
(43) Pub. Date: Dec. 23, 2010

(54) Replacing first sourced media with second sourced media based on first sourced media quality

(75) Inventors: James D. Bennett, Hroznetin (CZ); Jeyhan Karaoguz, Irvine, CA (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/696,570

(22) Filed: Jan. 29, 2010

Related U.S. Application Data
(60) Provisional application No. 61/218,039, filed on Jun. 17, 2009.
(60) Provisional application No. 61/218,045, filed on Jun. 17, 2009.

(51) Int. Cl. G06F 3/14; G06F 15/173; G06F 15/167

(52) U.S. Cl. 715/716; 709/226; 709/213; 709/223

(57) ABSTRACT

Replacing first sourced media with second sourced media based on first sourced media quality. A media processing device is operative to monitor the quality of first media and selectively to substitute second media in its place (in full or in part) based on a change in the quality of the first media. For example, in the context of first media received via broadcast (e.g., radio, satellite, streaming over the Internet, etc.), when a quality of the first media degrades, second media is substituted there for. The second media may be retrieved from a media storage device, or alternatively, it may be provided via another broadcast that has an acceptable quality level. The measure of quality of media may be characterized in accordance with any one or more parameters (e.g., change in signal to noise ratio (SNR), a discontinuity/gap, jitter, latency, etc.).

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional Patent Applications which are hereby incorporated herein by reference in their entirety and made part of the present U.S. Utility patent application for all purposes:

1. U.S. Provisional Application Ser. No. 61/218,039, entitled “Replacing first sourced media with second sourced media based on first sourced media quality,” (Attorney Docket No. BP20030), filed Jun. 17, 2009, pending.

2. U.S. Provisional Application Ser. No. 61/218,045, entitled “Media broadcast emulator,” (Attorney Docket No. BP20030.1), filed Jun. 17, 2009, pending.

### INCORPORATION BY REFERENCE

The following U.S. Utility patent application is hereby incorporated herein by reference in its entirety and is made part of the present U.S. Utility patent application for all purposes:

1. U.S. Utility application Ser. No. 12/______, entitled “Media broadcast emulator,” (Attorney Docket No. BP20030.1), filed concurrently on ______, pending.

### BACKGROUND OF THE INVENTION

1. Technical Field of the Invention

The invention relates generally to devices operable to output media; and, more particularly, it relates to management and processing of media to ensure an acceptable quality level of media that is output from such devices.

2. Description of Related Art

The amount of media available for user consumption and enjoyment continues to grow a staggering rate. There seems to be an insatiable market for providing news, media, and information to users. Users continually seek such information via a variety of avenues.

When media is provided from multiple sources, the quality of the media coming from the various sources may vary in many ways including varying in signal to noise ratio (SNR), clarity, etc. Typically, a user prefers to consume media that meets an acceptable quality level. There does not exist an adequate means in the art by which media that is output for consumption by a user may be ensured to have a sufficiently acceptable level of quality. Presently, in the art, user intervention is almost always required to make the selection of media provided from one media source from among the multiple media sources.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1A illustrates an embodiment of a computer.

FIG. 1B illustrates an embodiment of a laptop computer.

FIG. 1C illustrates an embodiment of a high definition (HD) television.

FIG. 1D illustrates an embodiment of a standard definition (SD) television.

FIG. 1E illustrates an embodiment of a handheld media unit.

FIG. 1F illustrates an embodiment of a set top box (STB).

FIG. 1G illustrates an embodiment of a digital video disc (DVD) player.

FIG. 1H illustrates an embodiment of a generic media processing device.

FIG. 2 illustrates an embodiment of an apparatus that is operative to output media selected from among at least two media sources.

FIG. 3 illustrates an embodiment of an apparatus that is operative to output media that is selected from among broadcast media and stored media.

FIG. 4 illustrates an embodiment of an apparatus that is operative to output media that is selected from one or more of a number of media sources.

FIG. 5 illustrates an embodiment of an apparatus that includes broadcast reception circuitry that is operative to receive media from one or more of a number of broadcast media sources.

FIG. 6 illustrates an embodiment of buffering of first media during analyzing of second media to identify quality degradation therein.

FIG. 7 illustrates an embodiment of combination of first media and second media to generate output media (shown as variants of third media).

FIG. 8 illustrates an embodiment of buffering of broadcast media and outputting of a combination of broadcast media (at least portions thereof) and stored media.

FIG. 9 illustrates an embodiment of selection among first and second media based on quality levels thereof.

FIG. 10 illustrates an alternative embodiment of selection among first and second media based on quality levels thereof.

FIGS. 11A, 11B, 12A, 12B, 13A, and 13B illustrate alternative embodiments of methods for outputting media, selected from at least two media sources, based on quality thereof.

### DETAILED DESCRIPTION OF THE INVENTION

A novel means is presented herein by which first media, or at least portions thereof, that is received from a first media source is selectively replaced by second media. The second media may be provided from the first media course or a second media source. In one embodiment, when quality of the first media is degraded (or degrades in real time), then it is replaced by the second media. The first media may be received via a media broadcast provider, and the second media may be retrieved from a media storage circuitry (e.g., a memory device). In such an embodiment that includes media provided from a media broadcast provider, when the quality of the broadcast media degrades, then media retrieved from the media storage circuitry is substituted (at least in part) for the portion of the first media whose quality is degraded.

There are a variety of types of devices that are operative to perform the management of supplemental content associated with such media to effectuate an improved user experience. Some examples of such devices are described below.

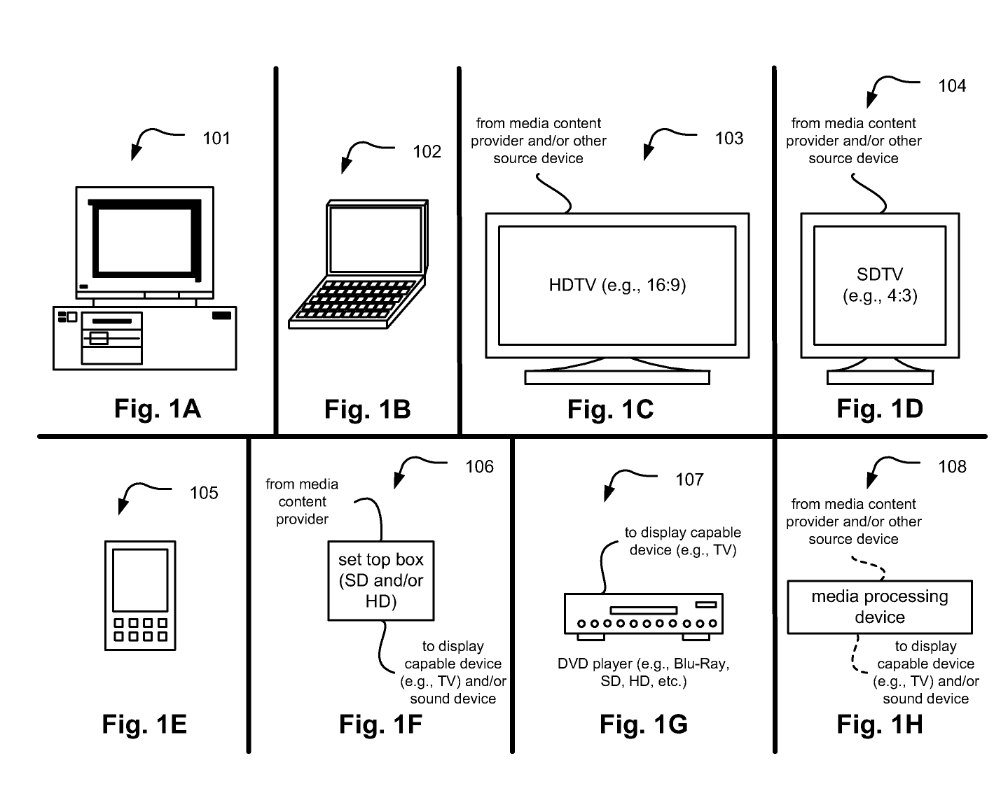

FIG. 1A illustrates an embodiment of a computer 101. The computer 101 can be a desktop computer, or an enterprise storage devices such a server, of a host computer that is attached to a storage array such as a redundant array of independent disks (RAID) array, storage router, edge router, storage switch and/or storage director. A user is able to view still digital images or video (e.g., a sequence of digital images) using the computer 101. Oftentimes, various image viewing capabilities and/or media player capabilities are included on a computer 101 to allow a user to view such images (including video). Also, certain embodiments of such a computer 101 can include one or more audio output devices (e.g., speakers either coupled to the computer 101 or integrated within the computer 101) to allow the outputting of audio content as well.

FIG. 1B illustrates an embodiment of a laptop computer 102. Such a laptop computer 102 may be found and used in any of a wide variety of contexts. In recent years, with the ever-increasing processing capability and functionality found within laptop computers, they are being employed in many instances where previously higher-end and more capable desktop computers would be used. As with the computer 101, the laptop computer 102 may include various image viewing capabilities and/or media player capabilities to allow a user to view such images (including video). The laptop computer 102 may also include or be coupled to one or more audio output devices (e.g., speakers).

FIG. 1C illustrates an embodiment of a high definition (HD) television 103. Many HD televisions 103 include an integrated tuner to allow the receipt, processing, and decoding of media content (e.g., television broadcast signals) thereon. Alternatively, sometimes an HD television 103 receives media content from another source such as a digital video disc (DVD) player, set top box (STB) that receives, processes, and decodes a cable and/or satellite television broadcast signal (or alternatively, an over the air broadcast signal). Regardless of the particular implementation, the HD television 103 may be implemented to perform media processing as described herein. Generally speaking, an HD television 103 has capability to display HD media content and oftentimes is implemented having a 16:9 widescreen aspect ratio. Clearly, other aspect ratios other than merely 16:9 may be implemented within such an HD television 103. Such an HD television 103 typically will include integrated speakers. Also, such a HD television 103 may be implemented cooperatively with an external sound system that outputs audio content.

FIG. 1D illustrates an embodiment of a standard definition (SD) television 104. Of course, an SD television 104 is somewhat analogous to an HD television 103, with at least one difference being that the SD television 104 does not include capability to display HD media content, and an SD television 104 oftentimes is implemented having a 4:3 full screen aspect ratio. Nonetheless, even an SD television 104 may be implemented to perform media processing as described herein. As mentioned above with respect to another television type, such an SD television 104 typically will include integrated speakers. Also, such a SD television 104 may be implemented cooperatively with an external sound system that outputs audio content.

FIG. 1E illustrates an embodiment of a handheld media unit 105. A handheld media unit 105 may operate to provide general storage or storage of image/video content information such as joint photographic experts group (JPEG) files, tagged image file format (TIFF), bitmap, motion picture experts group (MPEG) files, Windows Media Architecture (WMA) files, other types of video content such as MPEG4 files, etc. for playback to a user, and/or any other type of information that may be stored in a digital format. Historically, such handheld media units were primarily employed for storage and playback of audio media; however, such a handheld media unit 105 may be employed for storage and playback of virtual any media (e.g., audio media, video media, photographic media, etc.). Moreover, such a handheld media unit 105 may also include other functionality such as integrated communication circuitry for wired and wireless communications. Such a handheld media unit 105 may be implemented to perform media processing as described herein.

FIG. 1F illustrates an embodiment of a set top box (STB) 106. As mentioned above, sometimes a STB 106 may be implemented to receive, process, and decode a cable and/or satellite television broadcast signal to be provided to any appropriate display capable device such as SD television 104 and/or HD television 103. Such an STB 106 may operate independently or cooperatively with such a display capable device to perform media processing as described herein.

FIG. 1G illustrates an embodiment of a digital video disc (DVD) player 107. Such a DVD player may be any one of a Blu-Ray DVD player, an HD capable DVD player, an SD capable DVD player, and an up-sampling capable DVD player (e.g., from SD to HD, etc.) without departing from the scope and spirit of the invention. The DVD player may provide a signal to any appropriate display capable device such as SD television 104 and/or HD television 103. The DVD player 105 may be implemented to perform media processing as described herein.

FIG. 1H illustrates an embodiment of a generic media processing device 108. Again, as mentioned above, these various devices described above do not include an exhaustive list of devices in which the media processing described herein may be effectuated, and it is noted that any generic digital media processing device 108 may be implemented to perform the media processing described herein without departing from the scope and spirit of the invention.

It is noted that any of a wide variety of media capable devices may incorporate various aspects of the invention presented herein. While many such devices are described above with respect to FIGS. 1A-1H, these diagrams do not constitute an exhaustive list of such media capable devices, and any media capable device (e.g., including portable devices, multi-functional devices [such as a combined phone/media capable device], a media capable device implemented within a vehicle, etc.) may be implemented in accordance with the various aspects of the invention presented herein.

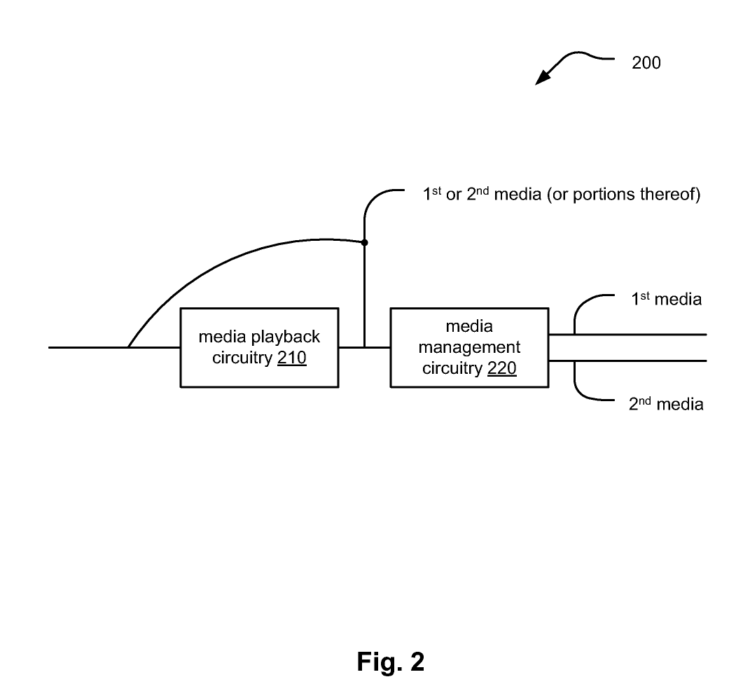

FIG. 2 illustrates an embodiment of an apparatus 200 that is operative to output media selected from among at least two media sources. For example, the first media is provided from a first media source, and the second media is provided from a second media source. In some embodiments, the first media source and the second media source are the same media source. In other embodiments, the first media is provided from a broadcast media source, and the second media is provided from a media storage device.

A media management circuitry 220 is operative to receive the first media and the second media. The media management circuitry 220 is operative to analyze the first media provided from the first media source to identify degradation in quality of the first media. Generally speaking, a change in the quality of the first media is identified during analysis of the first media. The measure of quality of media may be characterized in accordance with any one or more parameters (e.g., change in signal to noise ratio (SNR), a discontinuity/gap, jitter, latency, etc.).

A media playback circuitry 210 is operative initially to output the first media provided from the first media source. Then, based on the identified degradation in the quality of the first media, the media management circuitry 220 directs the media playback circuitry 210 to stop outputting the first media and to output second media provided from a second media source.

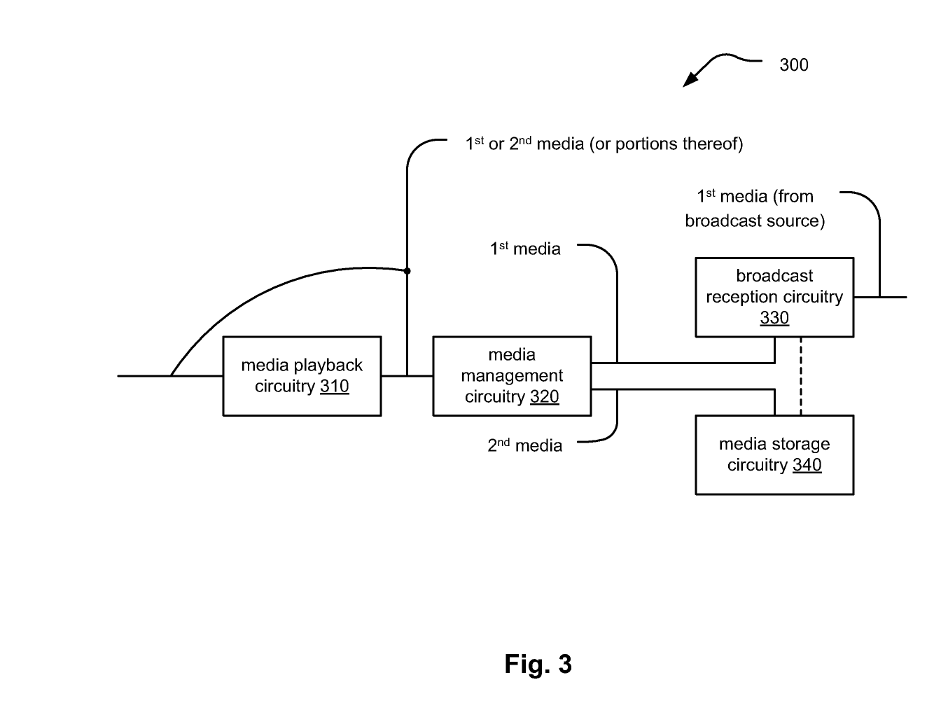

FIG. 3 illustrates an embodiment of an apparatus 300 that is operative to output media that is selected from among broadcast media and stored media. In this embodiment, a first media source is a broadcast source (e.g., radio [such as AM or FM], satellite [such as XM radio, Sirius, or some other service provider], streaming over the Internet, downloaded from the Internet, via some other wireless communication link [such as a Bluetooth supported communication link, a communication link within a wireless local area network (WLAN/WiFi)], etc.), and a second media source is a stored media source which is shown as a media storage circuitry 340 (e.g., a memory device such a hard disk drive (HDD), a read-only memory (RAM), random access memory (ROM), volatile memory, non-volatile memory, static memory, dynamic memory, flash memory, and/or any device that stores digital information). Referring to the diagram, the broadcast media is received via a broadcast reception circuitry 330, and the stored media is retrieved via a media storage circuitry 340.

The broadcast reception circuitry 330 is operative to receive the broadcast media provided from at least one of a plurality of broadcast media sources, and a media playback circuitry 310 is operative to output first media provided from one of the plurality of broadcast media sources. A media management circuitry 320 is operative to analyze the first media provided from one of the plurality of broadcast media sources to identify degradation in quality of the first media. Based on the identified degradation in the quality of the first media, the media management circuitry 320 directs the media playback circuitry 310 to stop outputting the first media and to output second media provided from the media storage circuitry 340.

The media output from the media playback circuitry 310 is a combination of at least some of the first media (received via the broadcast reception circuitry 330) and at least some of the second media (received from the media storage circuitry 340). In some embodiments, when the quality in the broadcast reception degrades, then for the period of time in which the quality is degraded, stored media is retrieved and output in place thereof.

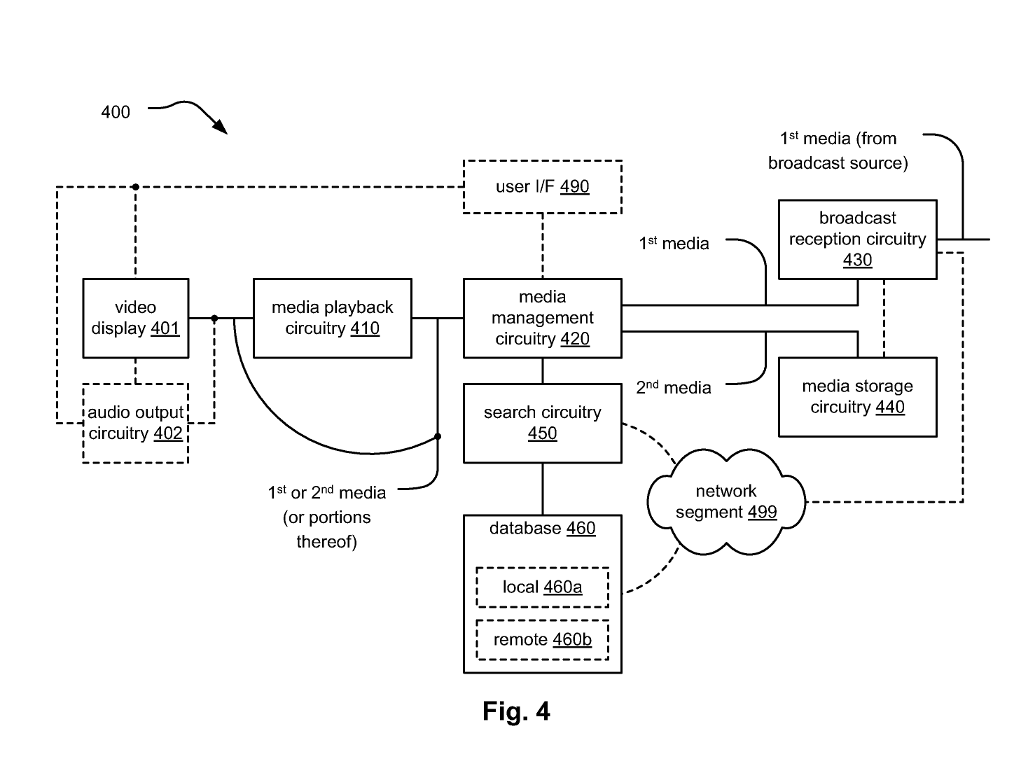

FIG. 4 illustrates an embodiment of an apparatus 400 that is operative to output media that is selected from one or more of a number of media sources. A broadcast reception circuitry 430 is operative to receive the broadcast media provided from at least one of a plurality of broadcast media sources, and a media playback circuitry 410 is operative to output first media provided from one of the plurality of broadcast media sources. A media management circuitry 420 is operative to analyze the first media provided from one of the plurality of broadcast media sources to identify degradation in quality of the first media. Based on the identified degradation in the quality of the first media, the media management circuitry 420 directs the media playback circuitry 410 to stop outputting the first media and to output second media provided from the media storage circuitry 440.

A search circuitry 450, coupled to the media management circuitry 450, is operative to access at least one database 460 (which may include a local database 460a and/or a remote database 460b) that may include media, ratings of media, a user-interactive forum to allow for updating of ratings, comments, etc. The database 460 may be accessed via a network segment 499 (e.g., an intranet connection, an Internet connection, a wireless local area network (WLAN/WiFi), etc.). In addition, the broadcast reception circuitry 430 may receive streaming media (or media that is downloaded) via the network segment 499.

A user interface 490 is operative to receive user input. This user interface 490 may include a means by which user input may be received so that a user may toggle between broadcast media and stored media. In alternative embodiments, this user interface 490 may also include a means to receive user input to replace a currently playing portion of media (e.g., a song) with another portion of media (e.g., another song retrieved from the media storage circuitry 440). Also, the user interface 490 may include a means by which user input may be received to rank or rate the currently playing media (e.g., ranking of a song currently being played); another type of input may also include a means by which the currently playing media may be added to a favorites list or other preferred playlist.

In some embodiments, the user interface 490 is operative to receive user input corresponding to a first user rating of the first media while the first media is being output by the media playback circuitry 410 or a second user rating of the second media while the second media is being output by the media playback circuitry 410. The media management circuitry 420 may include a memory circuitry that is operative to store at least one of the first user rating and the second user rating.

The media playback circuitry 410 may itself include an integrated display to display video or pictorial media and integrated speakers to output audio media (or the audio component of video or pictorial media). Alternatively, media that is output from the media playback circuitry 410 may be coupled to an external video display 401 to display video or pictorial media and/or an audio output circuitry 402 to output audio media (or the audio component of video or pictorial media).

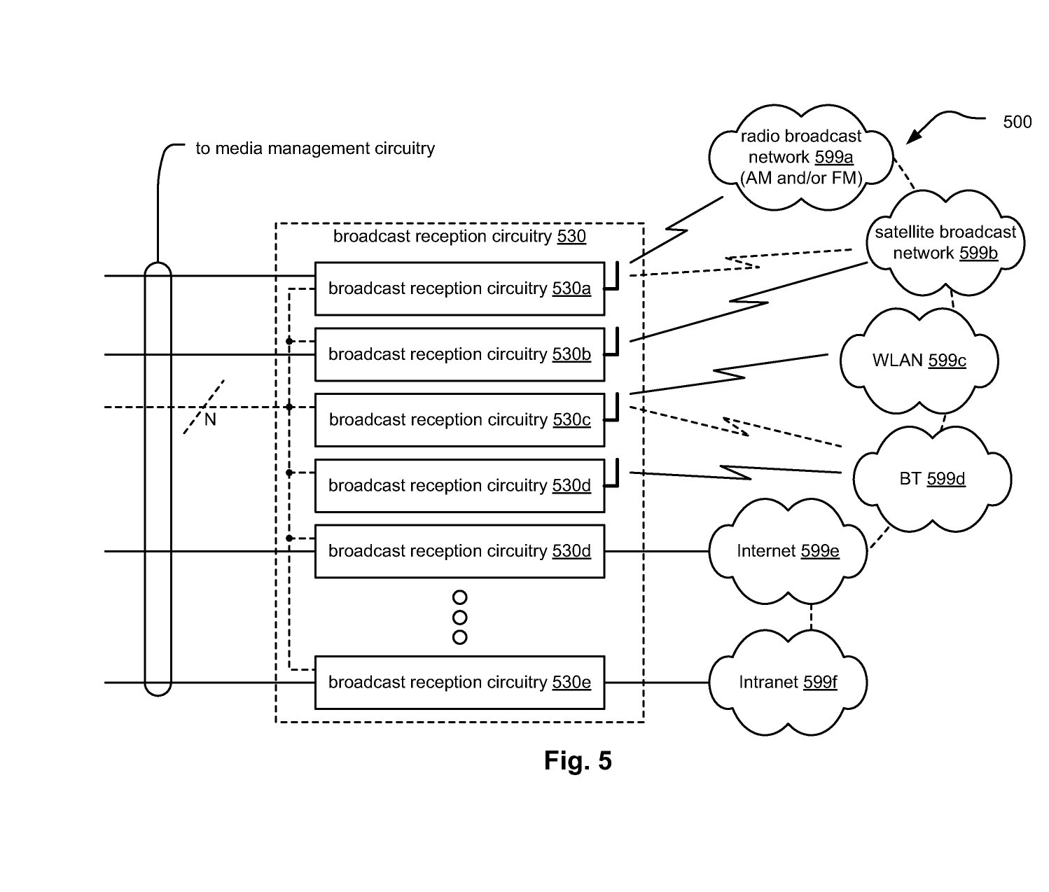

FIG. 5 illustrates an embodiment of an apparatus 500 that includes broadcast reception circuitry 530 that is operative to receive media from one or more of a number of broadcast media sources. In some embodiments, the broadcast reception circuitry 530 includes separate individual broadcast reception circuitries (e.g., shown by reference numerals 530a to 530e). For example, broadcast reception circuitry 530a is operative to receive wireless communications via a radio broadcast network 599a. Broadcast reception circuitry 530b is operative to receive wireless communications via a satellite broadcast network 599b; broadcast reception circuitry 530c is operative to receive wireless communications via a wireless local area network (WLAN/WiFi) 599c. Broadcast reception circuitry 530d is operative to receive wireless communications via a Bluetooth network 599d, broadcast reception circuitry 530a is operative to receive wireless communications wired communications via the Internet 599e, and broadcast reception circuitry 530e is operative to receive wired communications via an intranet 599f. It is noted that any of the various networks (wireless or wired) shown herein may also couple subsequently to the Internet 599e thereby allowing communications via the Internet 599e.

In some instances, one of the broadcast reception circuitries is operative to receive more than one type of communication. Consider the broadcast reception circuitry 530a that is operative to receive wireless communications via either a radio broadcast network 599a or a satellite broadcast network 599b. Alternatively, consider broadcast reception circuitry 530c that is operative to receive wireless communications via either a WLAN 599c or a BT wireless network 599b.

As desired in a particular application, the one or more signals received via the one or more broadcast reception circuitries 530a to 530e are provided to a media management circuitry.

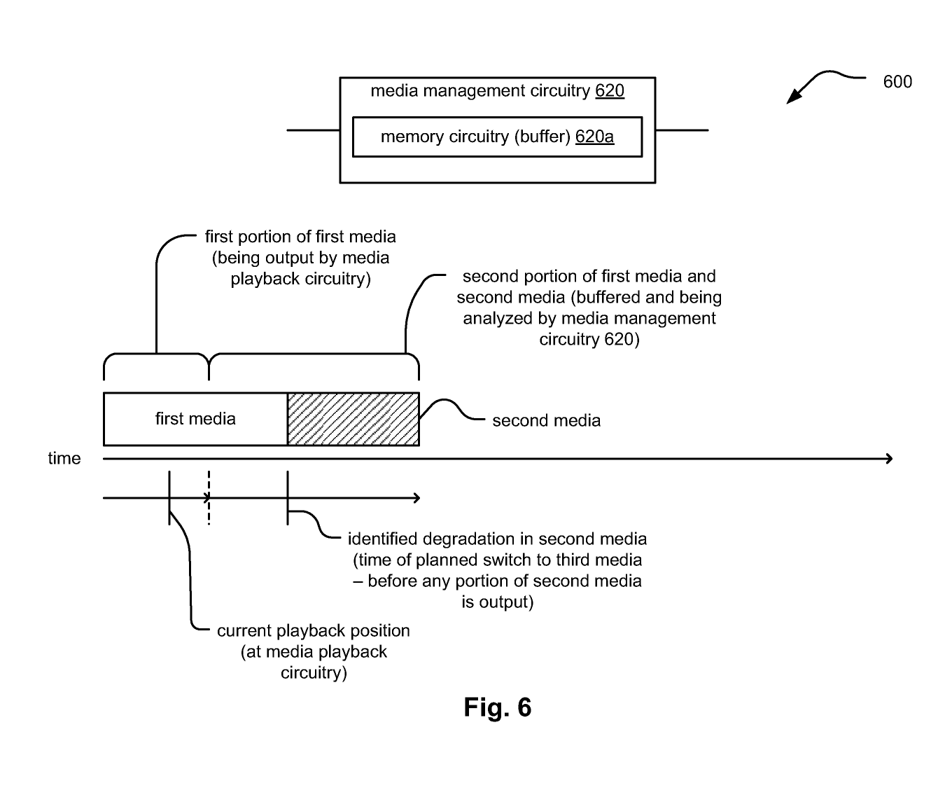

FIG. 6 illustrates an embodiment 600 of buffering of first media during analyzing of second media to identify quality degradation therein. This diagram shows the buffering of media so that some media may be output by a media playback circuitry while other portions of the media are being analyzed to identify degradation in quality thereof. For example, this buffering may be implemented using a memory circuitry (buffer) 620a that is implemented within a media management circuitry 620.

A timeline is shown that a first portion of first media is being output by media playback circuitry while a second portion of the first media is being buffered (along with second media) and analyzed by the media management circuitry 620 to identify media management circuitry 620. As can be seen, the amount of media that is buffered need not be aligned directly with segmented portions of the first media and the second media (e.g., at media boundaries which may coincide to song boundaries). However, in some embodiments, it is desirable to buffer portions of media at such boundaries, so that a first portion of a song does not get output via media playback circuitry if a second portion of that song has some degradation in quality (e.g., noise, a gap, a discontinuity, etc.).

When degradation in quality is quality is identified in the second media, then a switch is made to third media; this ensures that the second does not get output at all. In its place, third media (that does not have such degraded quality) is output to ensure an acceptably high quality level for a user's experience.

In certain types of media (e.g., a weather forecast or a news forecast), some portions of the media may simply be skipped if the degradation in quality is localized in time within an acceptable tolerance. For example, if a portion of media is a weather forecast that has been retrieved from some service provider, and if the media includes degradation in quality therein that is of a very short duration, it may still be desirable to output the portions of the media having a sufficiently high or acceptably high quality level (which are the vast majority thereof) via a media playback circuitry. However, for other types of media (e.g., music media), it may be undesirable to output such media via a media playback circuitry if the media has any portion therein having a degradation in quality. Such parameters that govern which types of media that are output may be set by user-selection (e.g., prohibit music from being output if it has any degradation in quality, allow news/weather forecast to be output even with degradation in quality [within a particular tolerance, which may also be set by a user], etc.).

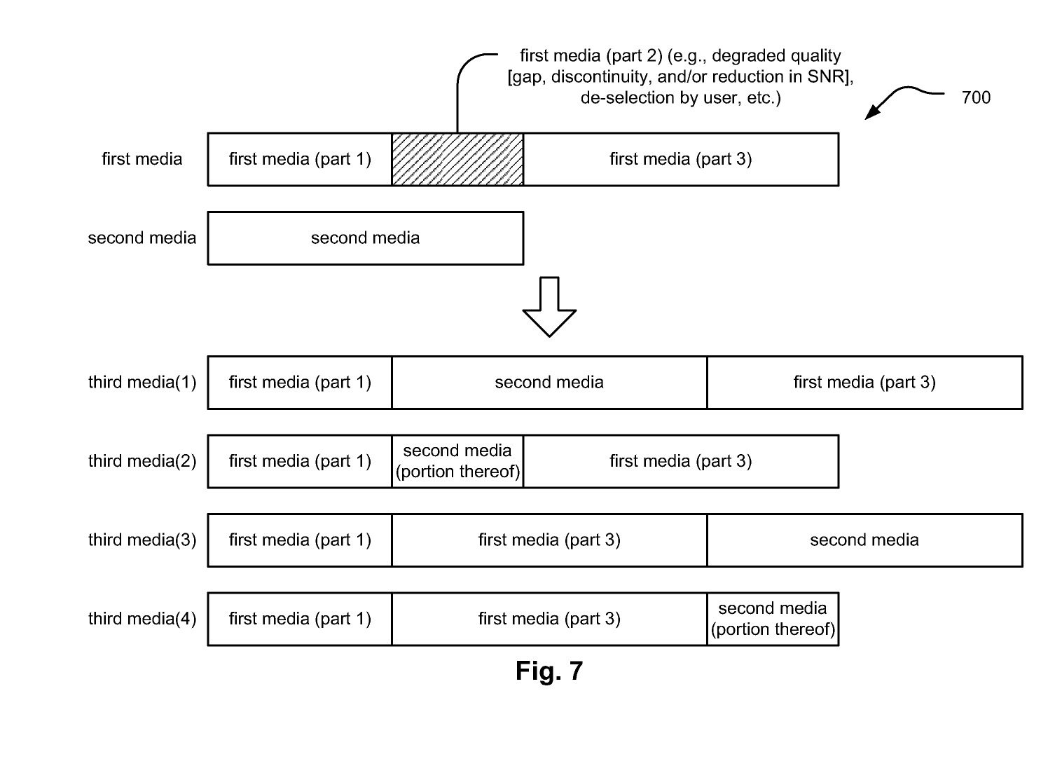

FIG. 7 illustrates an embodiment 700 of combination of first media and second media to generate output media (shown as variants of third media). This diagram shows an example of how output media is generated from first media and second media. The first media is shown as being partitioned into various parts (e.g., part 1, part 2, and part 3). Of these parts of the first media, only part 2 suffers from degradation in quality. Therefore, second media (that does not have such degradation in quality), is substituted in place of the part 2 of the first media. As can be seen, the size (e.g., length in time) of the second media is not same as the size of the second media. However, with some buffering and media management, an output media stream (e.g., shown as various embodiments of third media—such third media (1) through third media (4)) as may be generated by a media management circuitry for subsequent output via a media playback circuitry.

One possible version of output media, shown as third media (1), includes the part 1 of the first media, followed by the second media, followed by the part 3 of the first media. Another possible version of output media, shown as third media (2), includes the part 1 of the first media, followed by only a portion of the second media (e.g., whose length is similar to the length of the part 2 of the first media that has the degradation in quality), followed by the part 3 of the first media. Yet another possible version of output media, shown as third media (3), includes the part 1 of the first media, followed by the part 3 of the first media, and then followed by the second media. Even another possible version of output media, shown as third media (4), includes the part 1 of the first media, followed by the part 3 of the first media, and then followed by only a portion of the second media (e.g., whose length is similar to the length of the part 2 of the first media that has the degradation in quality).

There are a wide variety of combinations by which media may be substituted in place of a portion of media that has degraded quality. A preferred manner in which such media is substituted may be user-selected.

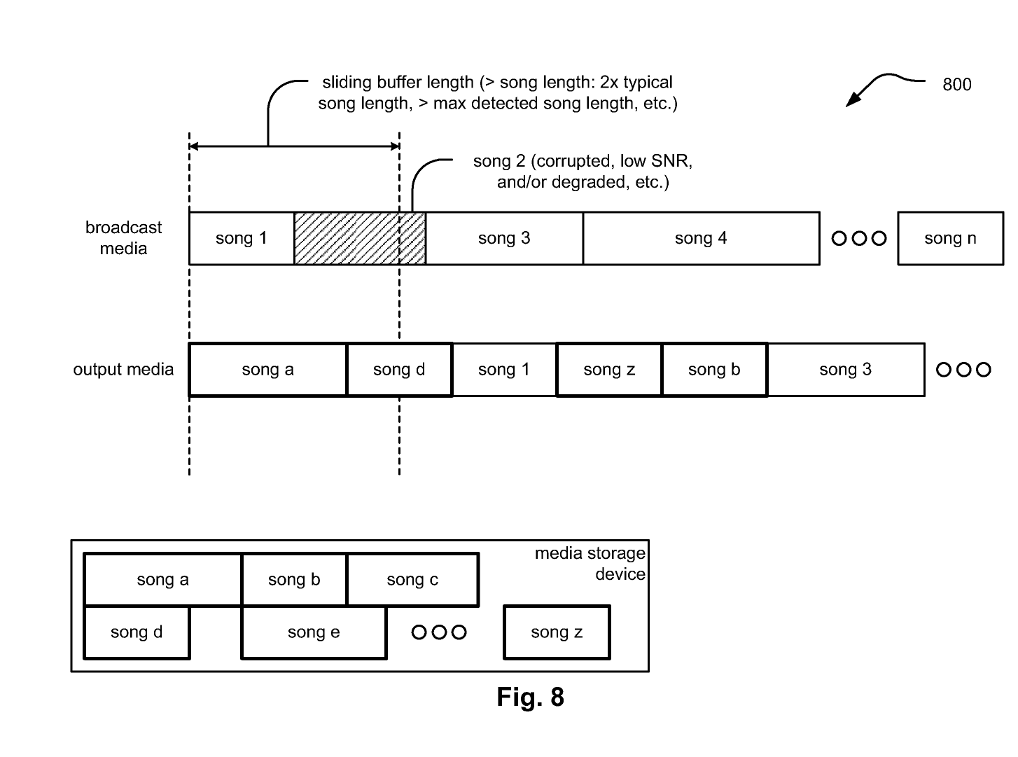

FIG. 8 illustrates an embodiment 800 of buffering of broadcast media and outputting of a combination of broadcast media (at least portions thereof) and stored media. This diagram shows yet another example of combination of different media that may be received from different sources.

Broadcast media composed of various segments (shown as songs in this embodiment) is received (e.g., such as via a broadcast reception circuitry as shown in other embodiments). Of course, broadcast media may alternatively include other types as well (e.g., news broadcasts, talk radio, weather forecasts, disk jockey commentary, emergency action system messages, etc.).

In this diagram, the broadcast media is buffered using a sliding buffer so that, at any given time, a particular amount of the broadcast media is contained in the buffer. In some embodiments, the buffer length may be set to be longer than a typical song length. For example, the buffer length may be set to be 2 times a typical song length; alternatively, the buffer length may be set to be longer than a maximum song length detected or ever received.

Initially, before any of broadcast media is output, media retrieved from a media storage device is output (e.g., shown as song 1, song d). During the outputting of this stored media (song 1, song d), the broadcast media is being analyzed to identify any degradation in quality thereof. In this diagram, song 2 of the broadcast media is shown as having degradation in quality. As such, song 2 of the broadcast media does not get included in the output media. The output media is formed using portions of the broadcast media that do not include any degraded quality and stored media that also does not include any degraded quality. Stated another way, the only media meeting an acceptable quality level is included in the output media. This acceptable quality level may be adjusted (e.g., adaptively based on operating conditions, based on user input, etc.). as one example, when a communication device including such functionality as described herein is locate within a region in which all broadcast media incurs some degradation, a user may select a lower acceptable level of quality, so that at least some broadcast media may be included in the output media. Also, such user selection may be tailored specifically to the type of media for which degraded or lower quality may be tolerated (e.g., only for news media and weather forecasts and not tolerated for music media).

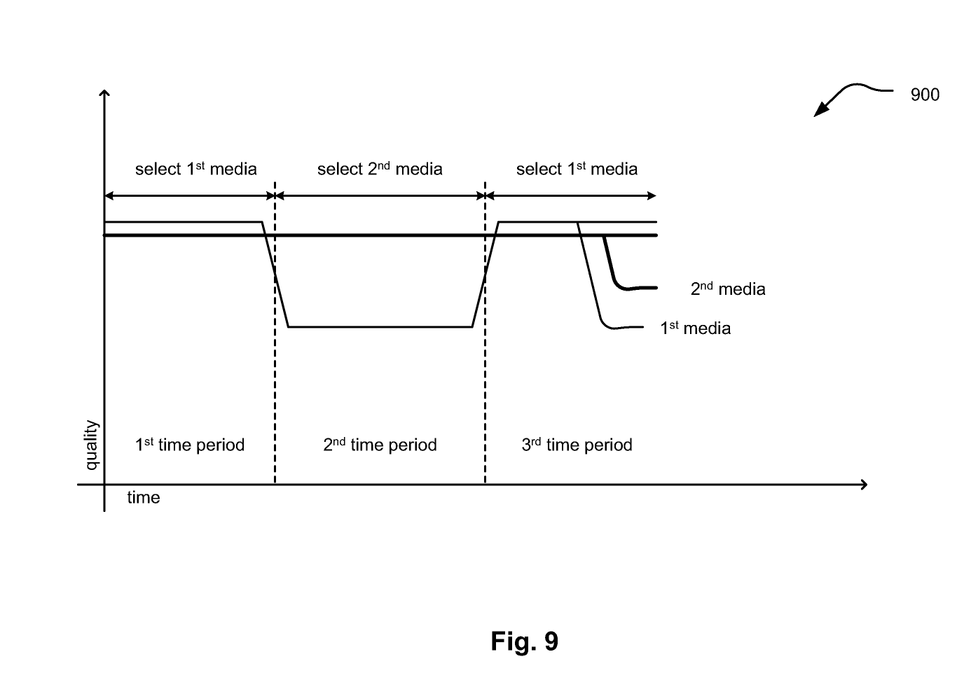

FIG. 9 illustrates an embodiment 800 of selection among first and second media based on quality levels thereof. This diagram pictorially shows degradation in quality of first media during a period of time. Otherwise, the quality of the first media actually exceeds the quality of the second media. Between these two media (first media and second media), the first media is selected during a first period of time when the quality of the first media is higher than the quality of the second media. Then, in a subsequent and adjacent time period, the quality of the first media degrades below the quality of the second media, and the second media is instead selected. During the following time period, the quality of the first media returns to its previous quality level, and the first media is selected.

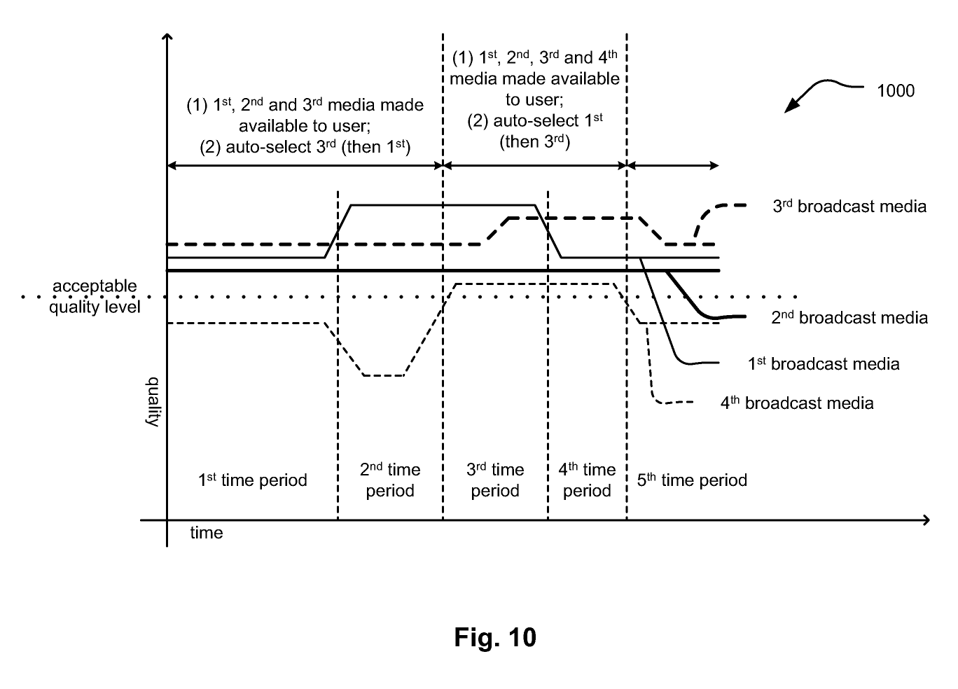

FIG. 10 illustrates an alternative embodiment 1000 of selection among first and second media based on quality levels thereof. This diagram shows the quality levels of multiple media relative to an acceptable quality level.

During each of a first and a second time period, each of a first, second, and third broadcast media have respective quality levels above the acceptable quality level. Only the fourth broadcast media has a quality level that is below the acceptable quality level during this first time period and second time period. Also, the quality of each of the first broadcast media and the fourth broadcast media incur changes in the quality thereof during the second time period (fourth broadcast media incurs degradation in quality, and first broadcast media incurs an increase in quality).

In a user-selected embodiment, each of the first, second, and third broadcast media may be made available as possible output media options to be selected by a user during the first and the second time period. In an auto-select embodiment (e.g., in which a circuitry automatically selects the media having the highest quality among a number of broadcast media options), the auto-select functionality may select the third broadcast media during the first time period, and then the auto-select functionality may select the first broadcast media during the second time period.

Considering the third and fourth time periods, each of a first, second, third, and fourth broadcast media have respective quality levels above the acceptable quality level. In a user-selected embodiment, each of the first, second, third, and fourth broadcast media may be made available as possible output media options to be selected by a user during the first and the second time period. In an auto-select embodiment, the auto-select functionality may select the first broadcast media during the third time period, and then the auto-select functionality may select the third broadcast media during the fourth time period.

As can be seen, depending on the quality of each of a number of broadcast media, the available broadcast media that are presented to a user for selection or the available broadcast media that are possible for auto-select may vary as a function of time.

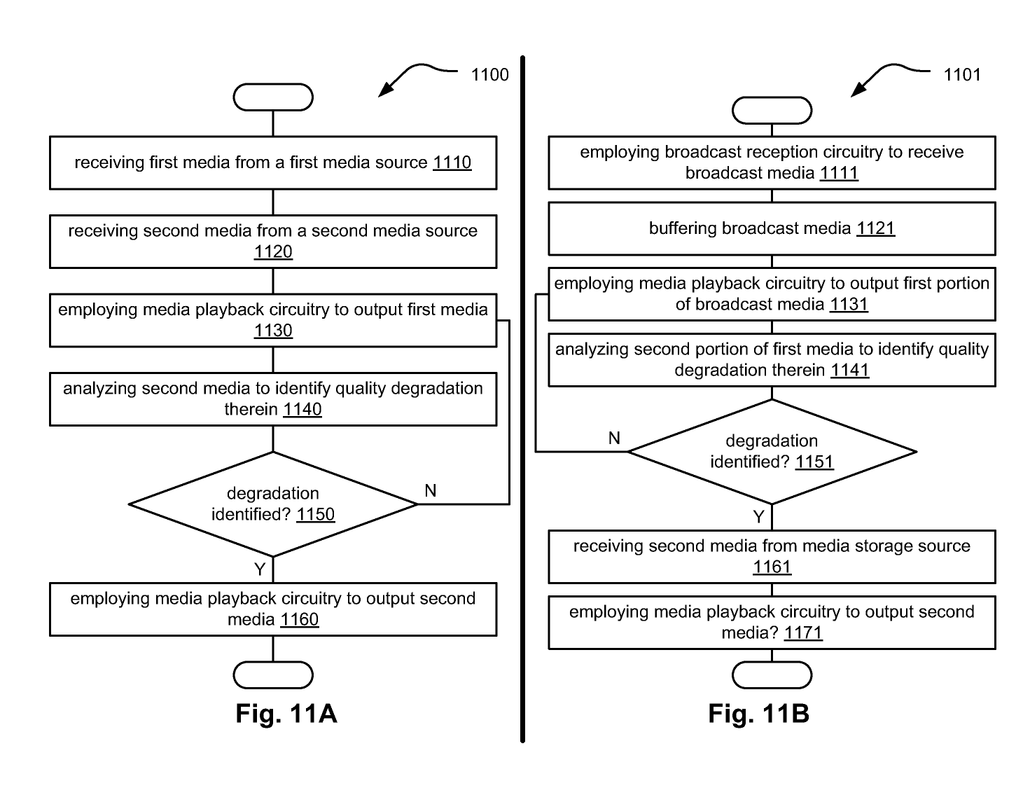

FIGS. 11A, 11B, 12A, 12B, 13A, and 13B illustrate alternative embodiments of methods for outputting media, selected from at least two media sources, based on quality thereof.

Referring to method 1100 of FIG. 11A, the method 1100 begins by receiving first media from a first media source, as shown in a block 1110. The method 1100 continues by receiving second media from a second media source, as shown in a block 1120. The method 1100 then operates by employing media playback circuitry to output first media, as shown in a block 1130. The method 1100 continues by analyzing second media to identify quality degradation therein, as shown in a block 1140.

As shown in a decision block 1150, the method 1100 operates by determining if there has been any identified degradation in quality. If there has not been any degradation in quality identified, then the method 1100 continues to the operations of the block 1130. Alternatively, if degradation in quality has been identified, then the method 1100 continues to the operations of the block 1160 that involves employing media playback circuitry to output second media.

Referring to method 1101 of FIG. 11B, the method 1101 begins by employing broadcast reception circuitry to receive broadcast media, as shown in a block 1111. The method 1101 then operates by buffering broadcast media, as shown in a block 1121. The method 1101 continues by employing media playback circuitry to output first portion of broadcast media, as shown in a block 1131.

The method 1101 then operates by analyzing second portion of first media to identify quality degradation therein, as shown in a block 1141. As shown in a decision block 1151, the method 1101 operates by determining if there has been any identified degradation in quality. If there has not been any degradation in quality identified, then the method 1101 continues to the operations of the block 1131. Alternatively, if degradation in quality has been identified, then the method 1101 continues to the operations of the block 1161 that involves receiving second media from media storage source. The method 1101 then operates by employing media playback circuitry to output second media, as shown in a block 1171.

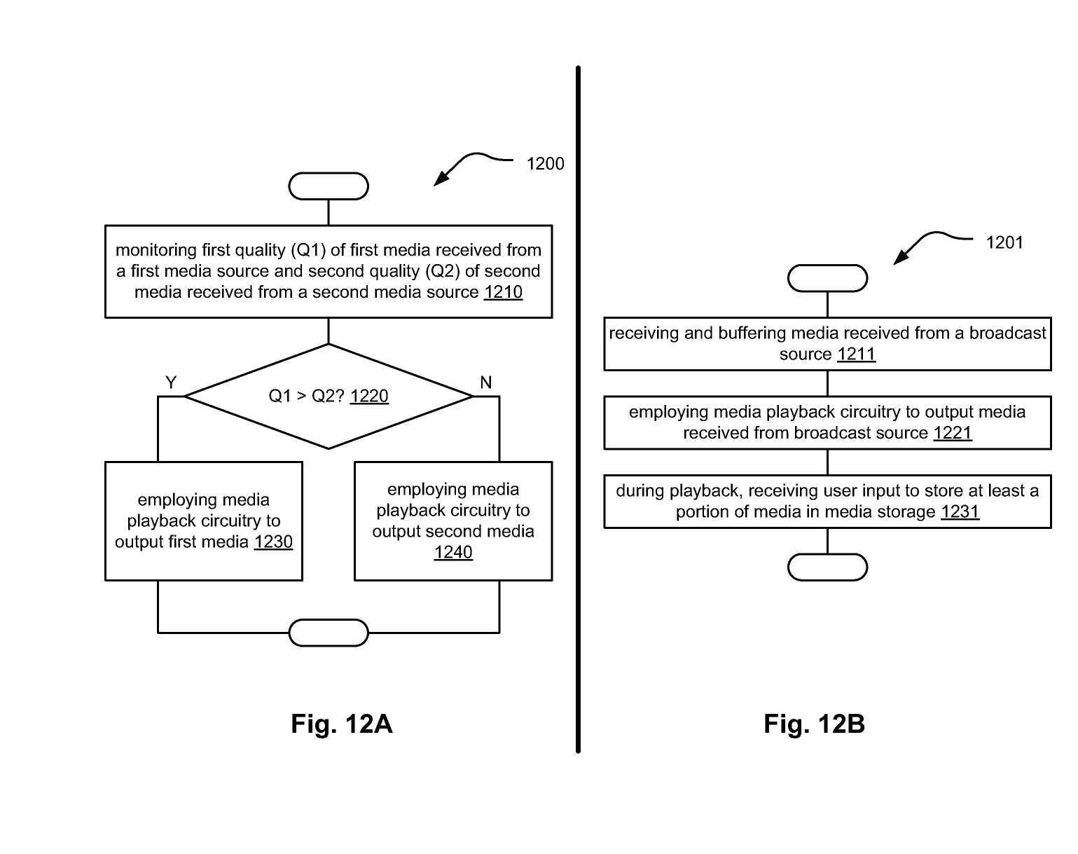

Referring to method 1200 of FIG. 12A, the method 1200 begins by monitoring first quality (Q1) of first media received from a first media source and second quality (Q2) of second media received from a second media source, as shown in a block 1210.

As shown in a decision block 1220, the method 1200 operates by determining which media has a higher quality. If the quality level is the same or within an acceptance tolerance of one another, then the method 1200 may continue to either the operations of block 1230 or 1240.

However, if the first quality (Q1) of the first media exceeds the second quality (Q2) of the second media, then the method 1200 continues to the operations of the block 1230 that involves employing media playback circuitry to output the first media. Alternatively, if the second quality (Q2) of the second media exceeds the first quality (Q1) of the first media, then the method 1200 continues to the operations of the block 1240 that involves employing media playback circuitry to output the second media.

Referring to method 1201 of FIG. 12B, the method 1201 begins by receiving and buffering media received from a broadcast source, as shown in a block 1211. The method 1201 then operates by employing media playback circuitry to output media received from broadcast source, as shown in a block 1221. The method 1201 continues by during playback, receiving user input to store at least a portion of media in media storage, as shown in a block 1231.

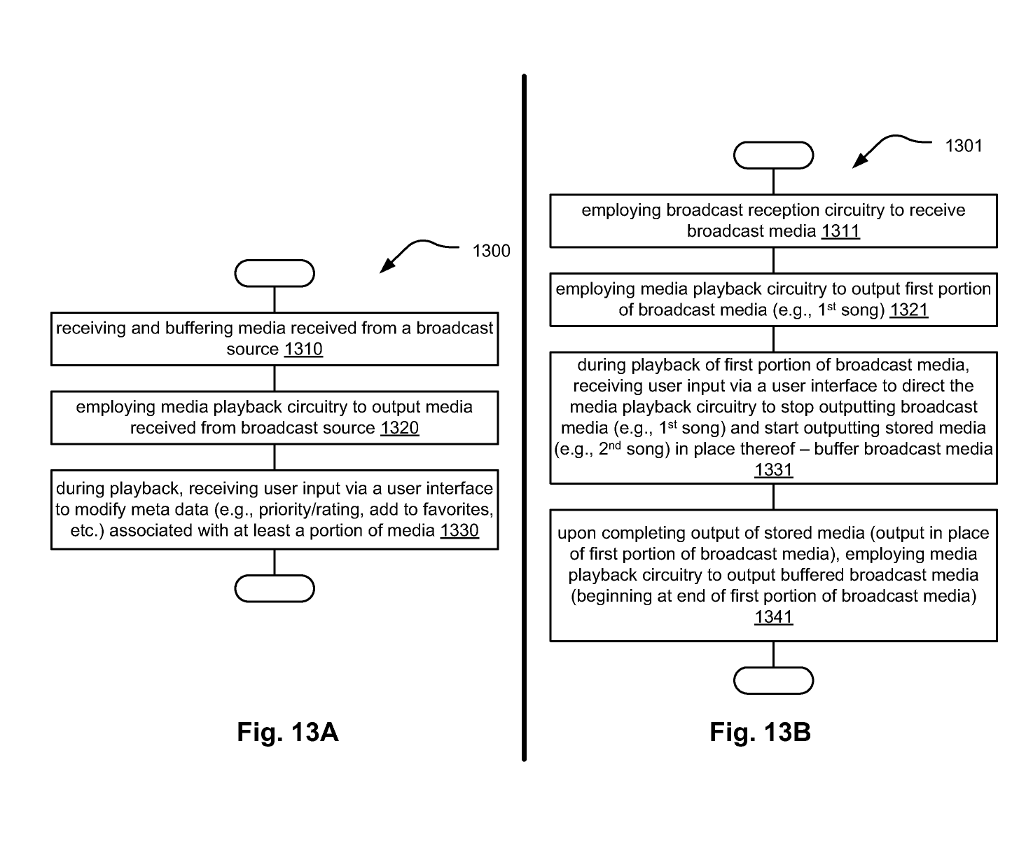

Referring to method 1300 of FIG. 13A, the method 1300 begins by receiving and buffering media received from a broadcast source, as shown in a block 1310. The method 1300 continues by employing media playback circuitry to output media received from broadcast source, as shown in a block 1320. The method 1300 then operates by during playback, receiving user input via a user interface to modify meta data (e.g., priority/rating, add to favorites, etc.) associated with at least a portion of media, as shown in a block 1330.

Referring to method 1301 of FIG. 13B, the method 1301 begins by employing broadcast reception circuitry to receive broadcast media, as shown in a block 1311. The method 1301 then operates by employing media playback circuitry to output first portion of broadcast media (e.g., 1^{st} song), as shown in a block 1321.

The method 1301 continues by during playback of first portion of broadcast media, receiving user input via a user interface to direct the media playback circuitry to stop outputting broadcast media (e.g., 1^{st} song) and start outputting stored media (e.g., 2^{nd} song) in place thereof—buffer broadcast media, as shown in a block 1331. The method 1301 then operates by upon completing output of stored media (output in place of first portion of broadcast media), employing media playback circuitry to output buffered broadcast media (beginning at end of first portion of broadcast media), as shown in a block 1341.

It is noted that the various circuitries and/or modules (e.g., media management circuitries, media playback circuitries, broadcast reception circuitries, media storage circuitries, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory (RAM), random access memory (ROM), volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a broadcast reception circuitry that is operative to receive broadcast media provided from at least one of a plurality of broadcast media sources;
a media playback circuitry, coupled to the broadcast reception circuitry, that is operative to output first media provided from one of the plurality of broadcast media sources;
a media storage circuitry that is coupled to the media playback circuitry; and
a media management circuitry, coupled to the broadcast reception circuitry, the media playback circuitry, and the media storage circuitry, that is operative to:
analyze the first media provided from one of the plurality of broadcast media sources to identify degradation in quality of the first media; and
based on the identified degradation in the quality of the first media, the media management circuitry directs the media playback circuitry to stop outputting the first media and to output second media provided from the media storage circuitry.

2. The apparatus of claim 1, wherein the media management circuitry includes a memory circuitry that is operative to:
buffer at least some of the first media such that the media management circuitry is operative to provide a first portion of the first media to the media playback circuitry while analyzing a second portion of the first media to identify the degradation in quality of the first media.

3. The apparatus of claim 1, further comprising:
a user interface, coupled to the media management circuitry, is operative to receive user input to direct the media management circuitry to provide a portion of the first media provided from one of the plurality of broadcast media sources to be stored in the media storage circuitry.

4. The apparatus of claim 1, wherein:
the broadcast reception circuitry is a first broadcast reception circuitry that is operative to receive first broadcast media provided from a first broadcast media source of the plurality of broadcast media sources; and further comprising:
a second broadcast reception circuitry, coupled to the media management circuitry, that is operative to receive second broadcast media provided from a second broadcast media source of the plurality of broadcast media sources.

5. The apparatus of claim 1, wherein:
the identified degradation in the quality of the first media is a discontinuity in the first media.

6. The apparatus of claim 1, wherein:
the identified degradation in the quality of the first media is a reduction in signal to noise ratio (SNR) of the first media.

7. The apparatus of claim 1, further comprising:
a user interface, coupled to the media management circuitry, is operative to receive user input to direct the media management circuitry to replace a portion of the first media with a portion of the second media thereby generating modified first media; and wherein:
the media playback circuitry is operative to output the modified first media.

8. The apparatus of claim 1, further comprising:
a user interface, coupled to the media management circuitry, is operative to receive user input corresponding to a first user rating of the first media while the first media is being output by the media playback circuitry or a second user rating of the second media while the second media is being output by the media playback circuitry; and wherein:
the media management circuitry includes a memory circuitry that is operative to store at least one of the first user rating and the second user rating.

9. An apparatus, comprising:
a media playback circuitry that is operative to output first media provided from a first media source; and
a media management circuitry, coupled to the media playback circuitry, that is operative to:
analyze the first media provided from the first media source to identify degradation in quality of the first media; and
based on the identified degradation in the quality of the first media, the media management circuitry directs the media playback circuitry to stop outputting the first media and to output second media provided from a second media source.

10. The apparatus of claim 9, wherein the media management circuitry includes a memory circuitry that is operative to:
buffer at least some of the first media such that the media management circuitry is operative to provide a first portion of the first media to the media playback circuitry while analyzing a second portion of the first media to identify the degradation in quality of the first media.

11. The apparatus of claim 9, wherein:
the first media source is a broadcast media source; and
the second media source is a media storage circuitry.

12. The apparatus of claim 9, wherein:
the first media provided from the first media source is broadcast media provided from a broadcast media source; and
the second media provided from the second media source is stored media provided from a media storage circuitry that is coupled to the media management circuitry; and further comprising:
a user interface, coupled to the media management circuitry, is operative to receive user input to direct the media management circuitry to provide a portion of the broadcast media to be stored in the media storage circuitry.

13. The apparatus of claim 9, wherein:
the first media source is a first broadcast media source; and
the second media source is a second broadcast media source.

14. The apparatus of claim 9, wherein:
the first media source is a first broadcast media source; and
the second media source is a second broadcast media source; and further comprising:
a first broadcast reception circuitry, coupled to the media management circuitry, that is operative to receive the first broadcast media provided from the first broadcast media source; and
a second broadcast reception circuitry, coupled to the media management circuitry, that is operative to receive the second broadcast media provided from the second broadcast media source.

15. The apparatus of claim 9, wherein:
the first media source is a broadcast media source;
the first media is broadcast media; and
the identified degradation in the quality of the first media is a discontinuity in the broadcast media provided from the broadcast media source.

16. The apparatus of claim 9, wherein:
the first media source is a broadcast media source;
the first media is broadcast media; and
the identified degradation in the quality of the first media is a reduction in signal to noise ratio (SNR) of the broadcast media provided from the broadcast media source.

17. The apparatus of claim 9, further comprising:
a user interface, coupled to the media management circuitry, is operative to receive user input to direct the media management circuitry to replace a portion of the first media with a portion of the second media thereby generating modified first media; and wherein:
the media playback circuitry is operative to output the modified first media.

18. The apparatus of claim 9, further comprising:
a user interface, coupled to the media management circuitry, is operative to receive user input to direct the media management circuitry to replace a portion of the first media with a portion of the second media thereby generating modified first media; and wherein:
the media playback circuitry is operative to output the modified first media; and
a rating of the portion of the first media is modified based on its replacement by a portion of the second media.

19. The apparatus of claim 9, further comprising:
a user interface, coupled to the media management circuitry, is operative to receive user input to direct the media management circuitry to output the second media provided from the second media source.

20. The apparatus of claim 9, further comprising:
a broadcast reception circuitry, coupled to the media management circuitry, that is operative to receive a plurality of broadcast media provided from a plurality of broadcast media sources; and wherein:
the first media is first broadcast media of the plurality of broadcast media provided from a first broadcast media source of the plurality of broadcast media sources;
the second media is second broadcast media of the plurality of broadcast media provided from a second broadcast media source of the plurality of broadcast media sources;
the media management circuitry is operative to select the second broadcast media source of the plurality of broadcast media sources based on a signal to noise ratio (SNR) of the second broadcast media source of the plurality of broadcast media sources compared to a SNR of a third broadcast media source of the plurality of broadcast media sources.

21. The apparatus of claim 9, further comprising:
a user interface, coupled to the media management circuitry, is operative to receive user input corresponding to a first user rating of the first media while the first media is being output by the media playback circuitry or a second user rating of the second media while the second media is being output by the media playback circuitry; and wherein:
the media management circuitry includes a memory circuitry that is operative to store at least one of the first user rating and the second user rating.

22. A method, comprising:
employing a media playback circuitry to output first media provided from a first media source;
analyzing the first media provided from the first media source to identify degradation in quality of the first media, the degradation corresponding to at least one of a reduction in signal to noise ratio (SNR) of the first media and a discontinuity in the first media;
based on the identified degradation in the quality of the first media, directing the media playback circuitry to stop outputting the first media and to output second media provided from a second media source; and
buffering at least some of the first media such that a first portion of the first media is provided to the media playback circuitry while a second portion of the first media is analyzed to identify the degradation in quality of the first media.

23. The method of claim 22, wherein:
the first media source is a broadcast media source; and
the second media source is a media storage circuitry.

24. The method of claim 22, wherein:
the first media provided from the first media source is broadcast media provided from a broadcast media source; and
the second media provided from the second media source is stored media provided from a media storage circuitry; and further comprising:
employing a user interface to receive user input that directs storing of a portion of the first media in the media storage circuitry.

25. The method of claim 22, wherein:
the first media source is a first broadcast media source; and
the second media source is a second broadcast media source; and further comprising:
employing a first broadcast reception circuitry to receive the first broadcast media provided from the first broadcast media source; and
employing a second broadcast reception circuitry to receive the second broadcast media provided from the second broadcast media source.

26. The method of claim 22, further comprising:
employing a user interface to receive user input that directs replacement of a portion of the first media with a portion of the second media thereby generating modified first media; and wherein:
employing the media playback circuitry to output the modified first media.

27. The method of claim 22, further comprising:
employing a user interface to receive user input corresponding to a first user rating of the first media while the first media is being output by the media playback circuitry or a second user rating of the second media while the second media is being output by the media playback circuitry; and
storing at least one of the first user rating and the second user rating in a memory circuitry.
